(19) United States
(12) Patent Application Publication
(10) Pub. No.: US 2026/0157387 A1
(43) Pub. Date: Jun. 11, 2026

(54) FORMULA FOR HERBAL BEVERAGE OF EXOCARPIUM CITRI RUBRUM AND PLATYCODON GRANDIFLORUS AND PREPARATION METHOD THEREOF

(71) Applicant: AIKERUIRAN (HONG KONG ) INDUSTRIAL LIMITED, HONG KONG (CN)

(72) Inventor: WAI YU CHENG, HONG KONG (CN)

(73) Assignee: AIKERUIRAN (HONG KONG ) INDUSTRIAL LIMITED, HONG KONG (CN)

(21) Appl. No.: 18/975,652

(22) Filed: Dec. 10, 2024

(51) Int. Cl. A23F 3/18

(52) U.S. Cl. CPC A23F 3/18

(57) ABSTRACT

The disclosure relates to the field of formulas for herbal beverages and preparation methods thereof, in particular to a formula for a herbal beverage of Exocarpium Citri Rubrum and Platycodon Grandiflorus and a preparation method thereof. The formula includes the following Chinese herbs: Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae. The formula for the herbal beverage of Exocarpium Citri Rubrum and Platycodon Grandiflorus of the disclosure, which includes Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae as ingredients, is used for symptoms of acute lung injury, bronchial asthma, and pulmonary nodules.

### TECHNICAL FIELD

The disclosure relates to the field of formulas for herbal beverages and preparation methods thereof, in particular to a formula for a herbal beverage of Exocarpium Citri Rubrum and Platycodon Grandiflorus and a preparation method thereof.

### BACKGROUND

Herbal beverages of Exocarpium Citri Rubrum and Platycodon Grandiflorus on the market take Exocarpium Citri Rubrum, Platycodon Grandiflorus, Lonicera Japonica, Pericarpium Citri Reticulatae, Siraitae Fructus, and Radix Glycyrrhizae as main ingredients. Through experiments of the herbal beverages of Exocarpium Citri Rubrum and Platycodon Grandiflorus on acute lung injury, bronchial asthma and pulmonary nodules, it was found that the effects of the herbal beverages of Exocarpium Citri Rubrum and Platycodon Grandiflorus on acute lung injury, bronchial asthma and pulmonary nodules were as follows: the herbal beverages of Exocarpium Citri Rubrum and Platycodon Grandiflorus have certain effect on expelling phlegm to arrest coughing, but have no obvious improvement effect on bronchitis, asthma and pulmonary nodules.

Therefore, in order to solve the problem that the above-mentioned herbal beverages are not ideal for improving the symptoms of acute lung injury, bronchial asthma and pulmonary nodules, a formula for a herbal beverage of Exocarpium Citri Rubrum and Platycodon Grandiflorus and a preparation method thereof can be designed.

### SUMMARY

In order to overcome the problem of unsatisfactory effects of herbal beverages on improving symptoms of acute lung injury, bronchial asthma and pulmonary nodules, a technical solution of the disclosure is as follows.

A formula for a herbal beverage of Exocarpium Citri Rubrum and Platycodon Grandiflorus includes the following Chinese herbs: Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae.

Preferably, the formula for the herbal beverage of Exocarpium Citri Rubrum and Platycodon Grandiflorus includes the following components in parts by weight: 2-8 parts of Huazhou Exocarpium Citri Rubrum, 2-8 parts of Platycodon Grandiflorus, 2-8 parts of Semen Sterculiae Lychnophorae, 2-8 parts of Lycii Fructus, 1-6 parts of Houttuynia Cordata Thunb, 1-6 parts of Pericarpium Citri Reticulatae, 1-6 parts of Lonicera Japonica, 1-3 parts of Radix Glycyrrhizae, 2-10 parts of Astragalus Membranaceus, and 2-10 parts of Sinapis Semen.

Provided are a formula for a herbal beverage of Exocarpium Citri Rubrum and Platycodon Grandiflorus and a preparation method thereof, including the formula for the herbal beverage of Exocarpium Citri Rubrum and Platycodon Grandiflorus, the preparation method including the following steps:
step 1: weighing Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus membranaceus, Lonicera Japonica, Lycii Fructus and Radix Glycyrrhizae according to weight ratios;
step 2: soaking the Chinese herbs in warm water for 3-5 min and then taking them out, putting the Chinese herbs into a decoction pot, adding boiling water for decoction, and pouring filter residues after decocting for 4-6 h to obtain a liquid A;
step 3: adding boiling water again for decoction, and pouring filter residues after decocting for 4-6 h to obtain a liquid B;
step 4: pouring the liquid A into the liquid B and mixing well, concentrating the mixture into a standard concentration at a temperature of 25° C., and adding a condiment for flavoring to prepare a herbal beverage;
step 5: performing steam sterilization on the herbal beverage; and
step 6: packaging and labeling each 50 ML bottle.

Preferably, one of sugar, honey and xylitol can be used as the condiment in step 4.

Preferably, the liquid A and the liquid B in step 3 and step 4 need to be sieved with a 100-mesh sieve, and mixing time of the liquid A and the liquid B in step 3 and step 4 is 5-10 min.

Preferably, the herbal beverage prepared in step 4 needs to be concentrated to a relative density of 1.05-1.10.

Provided are a formula for a herbal beverage of Exocarpium Citri Rubrum and Platycodon Grandiflorus and a preparation method thereof, including the formula for the herbal beverage of Exocarpium Citri Rubrum and Platycodon Grandiflorus, the preparation method including the following steps:
step 1: weighing Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus membranaceus, Lonicera Japonica, Lycii Fructus and Radix Glycyrrhizae according to weight ratios;
step 2: cutting the Chinese herbs into 1-2 mm slices with a herb cutting machine, putting the Chinese herb slices into the drying box, and drying them at low temperature until the moisture of the Chinese herb slices is below 10%, and taking them out to cool naturally;
step 3: dissolving active ingredients in the Chinese herbs in a solvent by using an ultrasonic extraction instrument, and concentrating the Chinese herb liquid into a paste;
Step 4: dissolving the Chinese herb paste with a corresponding proportion of purified water, mixing well for 1 h, and adding a condiment for flavoring to prepare a herbal beverage;
step 5: performing steam sterilization on the herbal beverage; and
step 6: packaging and labeling each 50 ML bottle.

The disclosure has the following beneficial effects.

The formula for the herbal beverage of Exocarpium Citri Rubrum and Platycodon Grandiflorus of the disclosure, which includes Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae as ingredients, is used for symptoms of acute lung injury, bronchial asthma, and pulmonary nodules. The Platycodon Grandiflorus, Huazhou Exocarpium Citri Rubrum, Semen Sterculiae Lychnophorae and Lycii Fructus have the efficacies of expelling phlegm to arrest coughing. The Houttuynia Cordata Thunb, Pericarpium Citri Reticulatae, Lonicera Japonica and Radix Glycyrrhizae have the efficacies of clearing heat, detoxifying and reducing inflammations. The Sinapis Semen and Astragalus Membranaceus have the efficacies of warming the lungs and dissolving lumps. Regular drinking of the herbal beverage of Exocarpium Citri Rubrum and Platycodon Grandiflorus can achieve certain effects of expelling phlegm to arrest coughing, inhibiting the activation and migration of inflammatory cells, and reducing the inflammatory reaction in lung tissues, and show a significant improvement on bronchial asthma.

### DETAILED DESCRIPTION OF THE EMBODIMENTS

The disclosure will be further described below in conjunction with the examples.

### Example 1

The disclosure provided an example: a formula for a herbal beverage of Exocarpium Citri Rubrum and Platycodon Grandiflorus included the following Chinese herbs:
Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae.

Preferably, the formula for the herbal beverage of Exocarpium Citri Rubrum and Platycodon Grandiflorus included the following components in parts by weight: 6 parts of Huazhou Exocarpium Citri Rubrum, 6 parts of Platycodon Grandiflorus, 3 parts of Semen Sterculiae Lychnophorae, 2 parts of Lycii Fructus, 4 parts of Houttuynia Cordata Thunb, 2 parts of Pericarpium Citri Reticulatae, 3 parts of Lonicera Japonica, 1 part of Radix Glycyrrhizae, 3 parts of Astragalus Membranaceus, and 4 parts of Sinapis Semen.

Provided are a formula for a herbal beverage of Exocarpium Citri Rubrum and Platycodon Grandiflorus and a preparation method thereof, including the formula for the herbal beverage of Exocarpium Citri Rubrum and Platycodon Grandiflorus, the preparation method including the following steps:
step 1: weighing Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae according to weight ratios;
step 2: soaking the Chinese herbs in warm water for 5 min and then taking them out, putting the Chinese herbs into a decoction pot, adding boiling water for decoction, and pouring filter residues after decocting for 5 h to obtain a liquid A;
step 3: adding boiling water again for decoction, and pouring filter residues after decocting for 5 h to obtain a liquid B;
step 4: pouring the liquid A into the liquid B and mixing well, concentrating the mixture into a standard concentration at a temperature of 25° C., and adding a condiment for flavoring to prepare a herbal beverage;
step 5: performing steam sterilization on the herbal beverage; and
step 6: packaging and labeling each 50 ML bottle.

Preferably, one of sugar, honey and xylitol could be used as the condiment in step 4.

Preferably, the liquid A and the liquid B in step 3 and step 4 needed to be sieved with a 100-mesh sieve, and mixing time of the liquid A and the liquid B in step 3 and step 4 was 10 min.

The herbal beverage of Exocarpium Citri Rubrum and Platycodon Grandiflorus prepared by Example 1 had the effect of warming the lungs and dissolving lumps, expelling phlegm to arrest coughing, clearing heat, detoxifying and reducing inflammations, and could significantly improve the symptoms of acute lung injury, bronchial asthma and pulmonary nodules after drinking.

### Example 2

The disclosure provided an example: a formula for a herbal beverage of Exocarpium Citri Rubrum and Platycodon Grandiflorus included the following Chinese herbs: Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae.

Preferably, the formula for the herbal beverage of Exocarpium Citri Rubrum and Platycodon Grandiflorus included the following components in parts by weight: 8 parts of Huazhou Exocarpium Citri Rubrum, 6 parts of Platycodon Grandiflorus, 3 parts of Semen Sterculiae Lychnophorae, 3 parts of Lycii Fructus, 4 parts of Houttuynia Cordata Thunb, 2 parts of Pericarpium Citri Reticulatae, 3 parts of Lonicera Japonica, 2 part of Radix Glycyrrhizae, 5 parts of Astragalus Membranaceus, and 3 parts of Sinapis Semen.

Provided are a formula for a herbal beverage of Exocarpium Citri Rubrum and Platycodon Grandiflorus and a preparation method thereof, including the formula for the herbal beverage of Exocarpium Citri Rubrum and Platycodon Grandiflorus, the preparation method including the following steps:
step 1: weighing Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae according to weight ratios;
step 2: soaking the Chinese herbs in warm water for 5 min and then taking them out, putting the Chinese herbs into a decoction pot, adding boiling water for decoction, and pouring filter residues after decocting for 5 h to obtain a liquid A;
step 3: adding boiling water again for decoction, and pouring filter residues after decocting for 5 h to obtain a liquid B;
step 4: pouring the liquid A into the liquid B and mixing well, concentrating the mixture into a standard concentration at a temperature of 25° C., and adding a condiment for flavoring to prepare a herbal beverage;
step 5: performing steam sterilization on the herbal beverage; and
step 6: packaging and labeling each 50 ML bottle.

Preferably, one of sugar, honey and xylitol could be used as the condiment in step 4.

Preferably, the liquid A and the liquid B in step 3 and step 4 needed to be sieved with a 100-mesh sieve, and mixing time of the liquid A and the liquid B in step 3 and step 4 was 10 min.

Compared with the formula of Example 1, in the herbal beverage of Exocarpium Citri Rubrum and Platycodon Grandiflorus prepared by Example 2, Huazhou Exocarpium Citri Rubrum, Platycodon Grandiflorus and Semen Sterculiae Lychnophorae were added at higher doses, wherein the Huazhou Exocarpium Citri Rubrum had more obvious effects of diminishing inflammations, and the Platycodon Grandiflorus and Semen Sterculiae Lychnophorae had the effects of warming the lungs, and arresting and alleviating cough, and reducing symptoms such as cough caused by acute lung injury.

### Example 3

The disclosure provided an example: a formula for a herbal beverage of Exocarpium Citri Rubrum and Platycodon Grandiflorus included the following Chinese herbs:
Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae.

Preferably, the formula for the herbal beverage of Exocarpium Citri Rubrum and Platycodon Grandiflorus included the following components in parts by weight: 6 parts of Huazhou Exocarpium Citri Rubrum, 6 parts of Platycodon Grandiflorus, 3 parts of Semen Sterculiae Lychnophorae, 2 parts of Lycii Fructus, 4 parts of Houttuynia Cordata Thunb, 2 parts of Pericarpium Citri Reticulatae, 6 parts of Lonicera Japonica, 3 part of Radix Glycyrrhizae, 8 parts of Astragalus Membranaceus, and 7 parts of Sinapis Semen.

Provided are a formula for a herbal beverage of Exocarpium Citri Rubrum and Platycodon Grandiflorus and a preparation method thereof, including the formula for the herbal beverage of Exocarpium Citri Rubrum and Platycodon Grandiflorus, the preparation method including the following steps:
step 1: weighing Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae according to weight ratios;
step 2: soaking the Chinese herbs in warm water for 5 min and then taking them out, putting the Chinese herbs into a decoction pot, adding boiling water for decoction, and pouring filter residues after decocting for 5 h to obtain a liquid A;
step 3: adding boiling water again for decoction, and pouring filter residues after decocting for 5 h to obtain a liquid B;
step 4: pouring the liquid A into the liquid B and mixing well, concentrating the mixture into a standard concentration at a temperature of 25° C., and adding a condiment for flavoring to prepare a herbal beverage;
step 5: performing steam sterilization on the herbal beverage; and
step 6: packaging and labeling each 50 ML bottle.

Preferably, one of sugar, honey and xylitol could be used as the condiment in step 4.

Preferably, the liquid A and the liquid B in step 3 and step 4 needed to be sieved with a 100-mesh sieve, and mixing time of the liquid A and the liquid B in step 3 and step 4 was 10 min.

Compared with the formula of Example 1, in the formula for the herbal beverage of Exocarpium Citri Rubrum and Platycodon Grandiflorus prepared by Example 3, the Huazhou Lonicera Japonica, Radix Glycyrrhizae and Astragalus Membranaceus were added at higher doses, and the prepared herbal beverage of Exocarpium Citri Rubrum and Platycodon Grandiflorus was sweet and delicious, and could reconcile the coldness of other Chinese herbs, making the whole beverage relatively mild and be suitable for long-term drinking.

### Example 4

The disclosure provided an example: a formula for a herbal beverage of Exocarpium Citri Rubrum and Platycodon Grandiflorus included the following Chinese herbs: Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae.

Preferably, the formula for the herbal beverage of Exocarpium Citri Rubrum and Platycodon Grandiflorus included the following components in parts by weight: 6 parts of Huazhou Exocarpium Citri Rubrum, 6 parts of Platycodon Grandiflorus, 3 parts of Semen Sterculiae Lychnophorae, 2 parts of Lycii Fructus, 4 parts of Houttuynia Cordata Thunb, 2 parts of Pericarpium Citri Reticulatae, 3 parts of Lonicera Japonica, 1 part of Radix Glycyrrhizae, 3 parts of Astragalus Membranaceus, and 4 parts of Sinapis Semen.

Provided are a formula for a herbal beverage of Exocarpium Citri Rubrum and Platycodon Grandiflorus and a preparation method thereof, including the formula for the herbal beverage of Exocarpium Citri Rubrum and Platycodon Grandiflorus, the preparation method including the following steps:
step 1: weighing Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae according to weight ratios;
step 2: cutting the Chinese herbs into 1-2 mm slices with a herb cutting machine, putting the Chinese herb slices into the drying box, and drying them at low temperature until the moisture of the Chinese herb slices was below 10%, and taking them out to cool naturally;
step 3: dissolving active ingredients in the Chinese herbs in a solvent by using an ultrasonic extraction instrument, and concentrating the Chinese herb liquid into a paste;
Step 4: dissolving the Chinese herb paste with a corresponding proportion of purified water, mixing well for 1 h, and adding a condiment for flavoring to prepare a herbal beverage;
step 5: performing steam sterilization on the herbal beverage; and
step 6: packaging and labeling each 50 ML bottle.

The herbal beverage of Exocarpium Citri Rubrum and Platycodon Grandiflorus prepared by Example 3 had the same formula as Example 1, in which effective ingredients in the Chinese herbs were extracted by using an ultrasonic extraction method, with high extraction efficiency.

### Experimental Method:

(1) Forty-eight male C57BL/6 mice were randomly divided into a blank control group, an acute lung injury (ALI) group, low-dose, medium-dose and high-dose (0.8, 1.6 and 3.2 mL/d) groups of the herbal beverages of Exocarpium Citri Rubrum and Platycodon Grandiflorus prepared by the formulas of Example 1, Example 2 and Example 3 (which were administered by gavage, once a day for 1 week), and a Dexamethasone positive control group; intratracheal instillation of lipopolysaccharide was used to establish a mouse ALI model, and pathological changes of lung tissues were observed by means of HE staining; a flow cytometer was used to detect a proportion of neutrophils in bronchoalveolar lavage fluid (BALF); the contents of tumor necrosis factor α (TNF-α), interleukin 1β (IL-1β), IL-6 and IL-10 in BALF were detected by ELISA; and meanwhile, the myeloperoxidase (MPO) activity in lung tissue homogenate and the protein contents of I-κBα and NF-κB in lung tissues were detected.
(1) Forty-eight female C57BL/6 mice were randomly divided into a blank control group, a bronchial asthma group, low-dose, medium-dose and high-dose (0.8, 1.6 and 3.2 mL/d) groups of the herbal beverages of Exocarpium Citri Rubrum and Platycodon Grandiflorus prepared by the formulas of Example 1, Example 2 and Example 3 (which were administered by gavage, once a day for 1 week), and a Dexamethasone group; a bronchial asthma mouse model was established by intraperitoneal injection sensitization of ovalbumin and intranasal stimulation, and pathological changes in lung tissues were observed by means of HE staining and toluidine blue staining; and ELISA was used to detect the contents of IgE, IL-5 and IL-13 in the serum of the mice.

### Experimental Results:

Compared with the blank control group, the pathology of the lung tissues of the mice in the ALI group showed obvious inflammatory cell infiltration; the proportion of neutrophils, MPO activity and contents of TNF-α, IL-1β and IL-6 in BALF significantly increased (P<0.05), and the IL-10 content decreased (P<0.05); Western blot results showed that the protein content of I-κBα in lung tissues decreased, and the protein content of phosphorylated NF-κB increased (P<0.05); compared with the ALI group, the pathological inflammations in the lung tissues of the mice in the high-dose TPC groups of the herbal beverages of Exocarpium Citri Rubrum and Platycodon Grandiflorus prepared by the formulas of Example 1, Example 2 and Example 3 and the Dexamethasone group were significantly reduced; the proportion of neutrophils, myeloperoxidase activity and contents of TNF-α, IL-1β and IL-6 in BALF significantly decreased (P<0.05), and the IL-10 content increased (P<0.05); the protein content of I-κBα in lung tissues increased, and the protein content of phosphorylated NF-κB decreased (P<0.05); compared with the blank control group, the pathology of the lung tissues of the mice in the bronchial asthma group showed obvious infiltration of inflammatory cells and mast cells, and the contents of IgE and IL-13 in the serum of the mice increased (P<0.05); compared with the bronchial asthma group, the high-dose groups of the herbal beverages of Exocarpium Citri Rubrum and Platycodon Grandiflorus prepared by the formulas of Example 1, Example 2 and Example 3 and the Dexamethasone group had reduced pathological inflammation cells and mast cells in lung tissues of the mice; and the IgE content in the serum in the mice decreased (P<0.05), and the IL-13 content in the mice of the Dexamethasone group decreased (P<0.05).

Conclusion: the herbal beverages of Exocarpium Citri Rubrum and Platycodon Grandiflorus prepared by the formulas of Example 1, Example 2 and Example 3 could prevent lipopolysaccharide-induced acute lung injury in mice to a certain extent, and alleviate the allergic reaction of bronchial asthma model mice, with the mechanism being related to inhibiting inflammatory reaction, reducing mast cell infiltration and IgE generation.

What is claimed is:

1. A formula for a herbal beverage of Exocarpium Citri Rubrum and Platycodon Grandiflorus, comprising the following Chinese herbs: Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus Membranaceus, Lonicera Japonica, Lycii Fructus and Radix Glycyrrhizae.

2. The formula for the herbal beverage of Exocarpium Citri Rubrum and Platycodon Grandiflorus according to claim 1, comprising the following components in parts by weight: 2-8 parts of Huazhou Exocarpium Citri Rubrum, 2-8 parts of Platycodon Grandiflorus, 2-8 parts of Semen Sterculiae Lychnophorae, 2-8 parts of Lycii Fructus, 1-6 parts of Houttuynia Cordata Thunb, 1-6 parts of Pericarpium Citri Reticulatae, 1-6 parts of Lonicera Japonica, 1-3 parts of Radix Glycyrrhizae, 2-10 parts of Astragalus Membranaceus, and 2-10 parts of Sinapis Semen.

3. A preparation method of a formula for a herbal beverage of Exocarpium Citri Rubrum and Platycodon Grandiflorus, comprising the formula for the herbal beverage of Exocarpium Citri Rubrum and Platycodon Grandiflorus according to claim 2, the preparation method comprising the following steps:
step 1: weighing Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus membranaceus, Lonicera Japonica, Lycii Fructus and Radix Glycyrrhizae according to weight ratios;
step 2: soaking the Chinese herbs in warm water for 3-5 min and then taking them out, putting the Chinese herbs into a decoction pot, adding boiling water for decoction, and pouring filter residues after decocting for 4-6 h to obtain a liquid A;
step 3: adding boiling water again for decoction, and pouring filter residues after decocting for 4-6 h to obtain a liquid B;
step 4: pouring the liquid A into the liquid B and mixing well, concentrating the mixture into a standard concentration at a temperature of 25° C., and adding a condiment for flavoring to prepare a herbal beverage;
step 5: performing steam sterilization on the herbal beverage; and
step 6: packaging and labeling each 50 ML bottle.

4. The preparation method of the formula for the herbal beverage of Exocarpium Citri Rubrum and Platycodon Grandiflorus according to claim 3, wherein one of sugar, honey and xylitol can be used as the condiment in step 4.

5. The preparation method of the formula for the herbal beverage of Exocarpium Citri Rubrum and Platycodon Grandiflorus according to claim 3, wherein the liquid A and the liquid B in step 3 and step 4 need to be sieved with a 100-mesh sieve, and mixing time of the liquid A and the liquid B in step 3 and step 4 is 5-10 min.

6. The preparation method of the formula for the herbal beverage of Exocarpium Citri Rubrum and Platycodon Grandiflorus according to claim 3, wherein the herbal beverage prepared in step 4 needs to be concentrated to a relative density of 1.05-1.10.

7. A preparation method of a formula for a herbal beverage of Exocarpium Citri Rubrum and Platycodon Grandiflorus, comprising the formula for the herbal beverage of Exocarpium Citri Rubrum and Platycodon Grandiflorus according to claim 2, the preparation method comprising the following steps:
step 1: weighing Platycodon Grandiflorus, Huazhou Exocarpium Citri Rubrum, Sinapis Semen, Houttuynia Cordata Thunb, Semen Sterculiae Lychnophorae, Pericarpium Citri Reticulatae, Astragalus membranaceus, Lonicera Japonica, Lycii Fructus and Radix Glycyrrhizae according to weight ratios;
step 2: cutting the Chinese herbs into 1-2 mm slices with a herb cutting machine, putting the Chinese herb slices into the drying box, and drying them at low temperature until the moisture of the Chinese herb slices is below 10%, and taking them out to cool naturally;
step 3: dissolving active ingredients in the Chinese herbs in a solvent by using an ultrasonic extraction instrument, and concentrating the Chinese herb liquid into a paste;
Step 4: dissolving the Chinese herb paste with a corresponding proportion of purified water, mixing well for 1 h, and adding a condiment for flavoring to prepare a herbal beverage;
step 5: performing steam sterilization on the herbal beverage; and
step 6: packaging and labeling each 50 ML bottle.
